(19) United States
(12) Patent Application Publication
(10) Pub. No.: US 2024/0220575 A1
(43) Pub. Date: Jul. 4, 2024

(54) DOMAIN ADAPTATION METHOD FOR LONGITUDINAL DATA AND DEVICE USING THEREOF

(71) Applicant: AJOU UNIVERSITY INDUSTRY-ACADEMIC COOPERATION FOUNDATION, Suwon-si (KR)

(72) Inventors: Hyunjung Shin, Suwon-si (KR); Chang Hyung Hong, Seongnam-si (KR); Sang Joon Son, Seoul (KR); Hyun Woong Roh, Suwon-si (KR); Sunghong Park, Suwon-si (KR)

(73) Assignee: AJOU UNIVERSITY INDUSTRY-ACADEMIC COOPERATION FOUNDATION, Suwon-si (KR)

(21) Appl. No.: 18/398,170

(22) Filed: Dec. 28, 2023

(30) Foreign Application Priority Data
Dec. 30, 2022 (KR) 10-2022-0190406
Dec. 27, 2023 (KR) 10-2023-0192832

(51) Int. Cl. G06F 17/18

(52) U.S. Cl. CPC G06F 17/18

(57) ABSTRACT

A domain adaptation device for longitudinal data includes a first module that generates first transformation data using a projection matrix for domain transformation and a graph matrix for data filtering, a second module that determines a domain of the first transformation data, and a third module that determines a label of the first transformation data.

### STATEMENT REGARDING GOVERNMENT SPONSORED RESEARCH OR DEVELOPMENT

The present disclosure was developed in the task of a project to develop an artificial intelligence model for dementia precision medicine and diversification of diagnosis (Project identification number: 1711188850, Project number: 2021R1A2C2003474, Ministry name: Ministry of Science and ICT, Project management organization name: National Research Foundation of Korea, Research project name: Individual basic research (Ministry of Science and ICT), contribution rate: 10/100, project implementation organization name: Ajou University, research period: 2023.03.01˜2024.02.29.)

The present disclosure was developed in the task of a project of the Ajou DREAM Artificial Intelligence Innovation Talent Training Project (Project Identification Number: 1345360502, Project Number: 5199991014091, Ministry Name: Ministry of Education, Project Management Agency Name: National Research Foundation of Korea, Research Project Name: 4th Stage Brain Korea 21 Project (R&D), Contribution Rate: 10/100, name of project performing organization: Ajou University, research period: 2022.03.01˜2023.02.28.)

The present disclosure was developed in the task of a developing a voice phishing information collection, processing, and big data-based investigation support system (task identification number: 1711200908, task number: 2022-0-00653, ministry name: Ministry of Science and ICT, project management agency name: Information and Communication Planning and Evaluation Institute, This is a technology developed through Research Project Name: Development of Technology to Prevent Illegal Mobile Phone Use, Contribution Rate: 10/100, Project Implementation Agency Name: National Police University, Research Period: 2023.01.01˜2023.12.31.)

The present disclosure was developed in the task of the Artificial Intelligence Convergence Innovation Talent Training (Ajou University) Project (Project Identification Number: 1711197986, Project Number: 00255968, Ministry Name: Ministry of Science and ICT, Project Management Agency Name: Information and Communications Planning and Evaluation Institute, Research Project Name: Artificial Intelligence Convergence Innovation Talent This is a technology developed through training, contribution rate: 10/100, project performing organization name: Ajou University Industry-Academic Cooperation Foundation, research period: 2023.07.01˜2023.12.31.)

The present disclosure was developed in the task of a multimodal-multidomain-based machine learning algorithm for predicting dementia progression (Project identification number: 1345371666, Project number: 2022R1A6A3A01086784, Ministry name: Ministry of Education, Project management organization name: National Research Foundation of Korea, Research project name: Science and Engineering Research This is a technology developed through foundation construction, contribution rate: 40/100, project carrying out organization name: Ajou University Industry-Academic Cooperation Foundation, research period: 2023.09.01˜2024.08.31.)

The present disclosure was developed in the task of the Human-Environmental Interaction Beyond Target Platform Construction Project (Task Identification Number: 1465039357, Project Number: HR21C1003020023, Ministry Name: Ministry of Health and Welfare, Project Management Agency Name: Korea Health Industry Development Institute, Research Project Name: Research-oriented Hospital Development, Contribution Rate: 5/100, project carrying out organization name: Ajou University Industry-Academic Cooperation Foundation, research period: 2023.01.01˜2023.12.31.)

The present disclosure was developed in the task of a super-gap SUPER*Senior Total Health Care platform project (task identification number: 1465039698, task number: HR22C1734010023, ministry name: Ministry of Health and Welfare, project management agency name: Korea Health Industry Development Institute, research project name: Research-oriented hospital development, contribution rate: 5 This is a technology developed through/100, project performing organization name: Ajou University Hospital, research period: 2023.01.01˜2023.12.31.)

The present disclosure was developed in the task of a brain disease convergence research center project (project identification number: 1711191592, task number: 2019R1A5A2026045, ministry name: Ministry of Science and ICT, project management agency name: National Research Foundation of Korea, research project name: group research support, contribution rate: 10/100, task This is a technology developed through the name of the performing organization: Ajou University, research period: 2023.03.01˜2024.02.29.)

The present disclosure was developed in the task of the Innovative Chronic Cerebrovascular Disease Biobank (Detailed Project Number: KBN4-B02-2023-01) support project.

Meanwhile, in all the aspects of the inventive concept, there is no property interest in the government of the Republic of Korea.

### CROSS-REFERENCE TO RELATED APPLICATIONS

This application claims priority under 35 U.S.C. § 119 to Korean Patent Application No. 10-2022-0190406 filed on Dec. 30, 2022, Korean Patent Application No. 10-2023-0192832 filed on Dec. 27, 2023, in the Korean Intellectual Property Office, the disclosures of which are incorporated by reference herein in their entireties.

### BACKGROUND

The present disclosure relates to a domain adaptation device, and more particularly to a domain adaptation device for longitudinal data.

Domain adaptation for longitudinal data is a process of improving a model by considering the characteristics of a specific domain. This may improve the accuracy of the model by understanding and reflecting seasonality, periodicity, special events, or the like of data. Taking into account domain-specific characteristics also helps the model make more reliable predictions in that domain and improves its response to data imbalances and real-time updates. Domain adaptation is important for the model to learn the unique patterns of the domain and perform update in real time to reflect the latest information.

### SUMMARY

Embodiments of the present disclosure provide a domain adaptation device capable of determining a domain and a label for longitudinal data.

According to an embodiment, a domain adaptation device for longitudinal data includes a first module that generates first transformation data using a projection matrix for domain transformation and a graph matrix for data filtering, a second module that determines a domain of the first transformation data, and a third module that determines a label of the first transformation data.

The first module may calculate a first difference, which is a difference between manifold of the first transformation data and manifold of comparison data, and a second difference, which is a difference between distribution of the first transformation data and distribution of the comparison data, and modify the projection matrix such that the first difference and the second difference decrease.

The graph matrix may be a matrix in which a weight matrix is normalized, and the weight matrix may be set based on a graph of a covariance matrix of the comparison data.

The second difference may be calculated using the Kullback-Leibler divergence function.

The first transformation data is calculated by the following equation:

$${Z}_{t} = {X}_{t} PG$$

where Zₜ: first transformation data, Xₜ: input data, and P: projection matrix, and G: graph matrix.

The second difference is calculated by the following equation:

$$K ( P ) = KL ( {𝒫}_{t} \vert \vert {𝒫}_{T} ) = {\sum }_{i = 1}^{d} {𝒫}_{t}^{( i )} log ( \frac{{𝒫}_{t}^{( i )}}{{𝒫}_{T}^{( i )}} )$$

where K(P): second difference, KL: Kullback-Leibler divergence function, [symbol] : probability for a mean of the first transformation data, and [symbol] : probability for the comparison data.

The second module may determine the domain of the first transformation data based on a predetermined equation, and output a first value when the domain of the first transformation data is determined to be a first time point, and a second value when the domain of the first transformation data is determined to be a second time point.

The predetermined equation is as follows:

$${\hat{Y}}_{d} = \frac{1}{1 + {e}^{- z {θ}_{d}}}$$

where Ŷ_{d}: domain discrimination function, Z: first transformation data set, and θ_{d}: discrimination parameter.

The discrimination parameter may be optimized by minimizing a binary cross-entropy loss function between the domain discrimination function and a domain label set.

The binary cross-entropy loss function may be calculated by the following equation:

$$D ( P , {θ}_{d} ) = - [ {Y}_{d}^{T} log {\hat{Y}}_{d} + {( 1 - {Y}_{d} )}^{T} log ( 1 - {\hat{Y}}_{d} ) ]$$

where D(P, θ_{d}): binary cross-entropy loss function, Ŷ_{d}: domain discrimination function, and Y_{d}: domain label set.

The first module may generate second transformation data to which comparison data has been transformed using the projection matrix and the graph matrix, and the third module may determine a class and regression of the comparison data based on the second transformation data.

The third module may determine the class and regression of the comparison data using the following equation:

$${\hat{Y}}_{l} = softmax ( {Z}_{T} {θ}_{l} )$$

where Ŷₗ: label prediction function, Z_{T}: second transformation data, and θₗ: label parameter.

The label parameter may be optimized by minimizing the cross-entropy loss function between the label prediction function and a set of correct labels.

The cross-entropy loss function is calculated by the following equation:

$$L ( P , {θ}_{l} ) = - tr [ {Y}_{l}^{T} log {\hat{Y}}_{l} + {( 1 - {Y}_{l} )}^{T} log ( 1 - {\hat{Y}}_{l} ) ]$$

where L(P, θₗ): cross-entropy loss function, Ŷₗ: label prediction function, and Yₗ: a set of correct labels.

According to an embodiment, a domain adaptation method for longitudinal data, which is performed by at least one processor, includes generating first transformation data using a projection matrix for domain transformation and a graph matrix for data filtering, calculating a first difference, which is a difference between manifold of the first transformation data and manifold of comparison data, and a second difference, which is a difference between distribution of the first transformation data and distribution of the comparison data, and modifying the projection matrix such that the first difference and the second difference decrease.

According to an embodiment, there is provided a computer program stored in a computer-readable recording medium for executing the domain adaptation method for longitudinal data.

According to an embodiment of the present disclosure, a domain adaptation device may be provided, which is capable of determining a domain and a label for longitudinal data.

### BRIEF DESCRIPTION OF THE FIGURES

The above and other objects and features of the present disclosure will become apparent by describing in detail embodiments thereof with reference to the accompanying drawings.

FIG. 1 is a diagram for describing a domain adaptation device according to an embodiment.

FIG. 2 is a diagram for describing the structure of an artificial intelligence model included in a domain adaptation device according to an embodiment.

FIG. 3 is a diagram for describing a process for generating transformation data according to an embodiment.

FIG. 4 is a diagram for describing manifold of transformation data.

FIG. 5 is a diagram for describing a distribution of transformation data.

FIG. 6 is a diagram for describing a process for calculating a difference in distribution of transformation data.

FIG. 7 is a diagram for describing a second module according to an embodiment.

FIG. 8 is a diagram for describing a third module according to an embodiment.

FIG. 9 is a flowchart of a domain adaptation method for longitudinal data according to an embodiment.

FIGS. 10 and 11 show results of comparison in performance of between the prior art and the domain adaptation device of the present disclosure.

### DETAILED DESCRIPTION

Embodiments described in this specification are intended to clearly describe the spirit of the present disclosure to those skilled in the art to which the present disclosure pertains, and therefore the present disclosure is not limited to the embodiments described in this specification, and the scope of the present disclosure should be construed to include modifications or variations that do not depart from the spirit of the present disclosure.

The terms used herein are general terms that are currently widely used as much as possible in consideration of their function in the present disclosure, but may vary depending on the intention of a person skilled in the art in the technical field to which the present disclosure pertains, precedents, or the emergence of new technology. When a specific term is defined and used with an arbitrary meaning, the meaning of the term will be described separately. Accordingly, the terms used in the present specification are not to be defined as simple names of the components, but should be defined on the basis of the actual meaning of the terms and the whole context throughout the present specification.

The accompanying drawings are to facilitate the explanation of the present disclosure, and a shape in the drawings may be exaggerated for the purpose of convenience of explanation so the present disclosure is not limited to the drawings.

In the present specification, if it is determined that a detailed description of a known configuration or function related to the present disclosure may obscure the gist of the present disclosure, the detailed description thereof will be omitted as necessary.

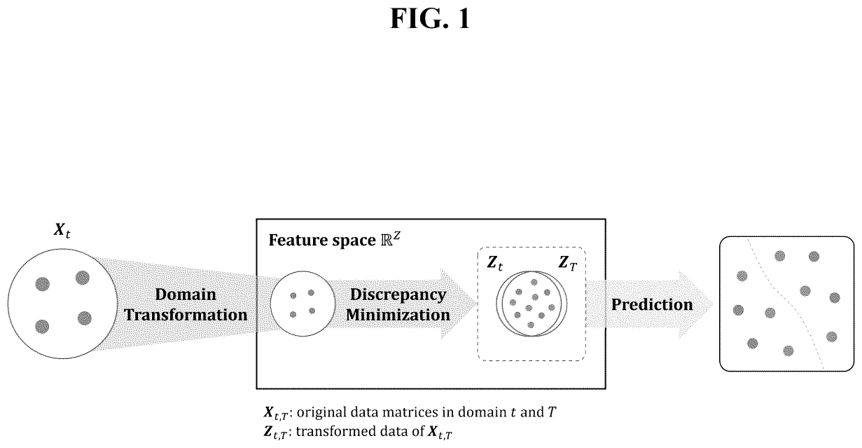

FIG. 1 is a diagram for describing a domain adaptation device according to an embodiment.

Referring to FIG. 1, a domain adaptation device according to an embodiment may transform a domain region of input data (X_t, for example, past data) and predict a label after minimizing a mismatch with comparison data (X_T, for example, current data or future data).

Specifically, the domain adaptation device may transform the domain of the input data. In this case, the domain adaptation device may generate first transformation data in which the domain of the input data has been transformed, by using a projection matrix P. Further, the domain adaptation device may extract desired features from the transformation data using a graph matrix G. For example, the domain adaptation device may extract a manifold and/or distribution of the first transformation data using use the graph matrix.

The domain adaptation device may continuously change the projection matrix such that a difference in manifold and a difference in distribution between the first transformation data to which the input data has been transformed and the comparison data are minimized. Accordingly, the domain adaptation device may include a projection matrix that is optimized through learning.

The domain adaptation device may predict a domain and label of the input data using the optimized projection matrix P. Specifically, the domain adaptation device may determine whether the domain of the input data is past or present (or future). Further, the domain adaptation device may determine a class and a regression of the input data using the optimized projection matrix.

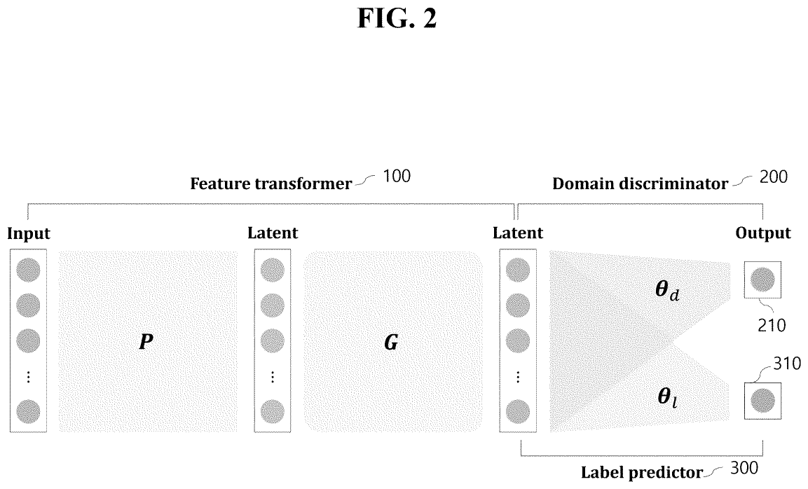

FIG. 2 is a diagram for describing the structure of an artificial intelligence model included in a domain adaptation device according to an embodiment.

Referring to FIG. 2, a domain adaptation device according to an embodiment may include a first module 100, a second module 200, and a third module 300. Although FIG. 2 illustrates three modules are included in the domain adaptation device, the domain adaptation device may include fewer or more components without limitation.

The first module 100, second module 200, and third module 300 of FIG. 2 may constitute a single artificial intelligence model. Accordingly, parameters may be optimized by learning from training data in the modules, and the artificial intelligence model may output result data based on the optimized parameters. Specifically, the artificial intelligence model may determine a domain and label of the input data using a projection matrix optimized through learning.

The first module 100 may include at least one processor that generates transformation data using a projection matrix and a graph matrix. The first module 100 may also be referred to as a feature transformer. Specifically, the first module 100 may generate first transformation data for the input data using a projection matrix for domain transformation and a graph matrix for data filtering.

Referring to FIG. 2, the first module 100 may receive input data. The first module 100 may generate first latent data using the input data and the projection matrix P. Thereafter, the first module 100 may generate second latent data using the first latent data and the graph matrix G. In this case, the second latent data may be transformation data.

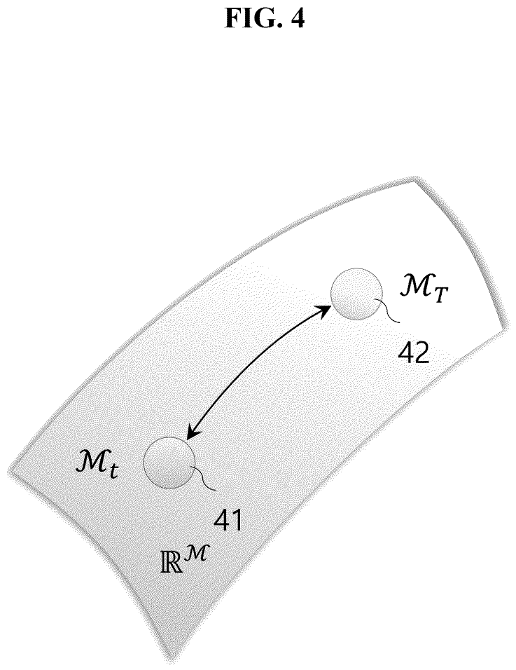

The first module 100 may continuously modify the projection matrix P to minimize a difference between the manifold of the first transformation data and the manifold of the comparison data. Also, the first module 100 may continuously modify the projection matrix P to minimize the difference between the distribution of the first transformation data and the distribution of the comparison data. The process of continuously modifying the projection matrix P may also be understood as a process by which the artificial intelligence model including the first module 100 is trained. Details will be described with reference to FIGS. 4 to 6.

In this case, the first transformation data may be data to which past data has been transformed. Further, the comparison data may be current or past data. For example, the first transformation data may be associated with past medical data of a certain patient, and the comparison data may be associated with current medical data of the certain patient. In another example, the first transformation data may be associated with past stock data and the comparison data may be associated with current stock data. As such, the domain adaptation apparatus of the present disclosure may be applied to longitudinal data without limitation.

The longitudinal data may refer to data collected to determine causal relationships between key factors. The longitudinal data may be data containing the same variables collected at specific time intervals for a certain research subject. The longitudinal data may include panel data and time series data.

The panel data may refer to data collected from a group of identical survey respondents (panel) of a reasonable number for the topic and purpose of survey, who are surveyed on the topic at regular intervals so as to track changes. Because the panel data is collected in such a way that the same data is collected repeatedly from the same sample, errors that occur when investigating different subjects may be reduced, and the direction and degree of change may be meaningfully identified.

The time series data may refer to data that is repeatedly collected on the attributes of populations or data that is collected through repeated surveys of the same population. Further, the time series data may refer to data in which similar variables are collected at multiple time points.

The domain device of the present disclosure may predict current data or future data using past data, which is longitudinal data. For example, the present disclosure may predict current medical data using a patient's past medical data. Also, for example, the present disclosure may predict current stock data using past stock data. However, the present disclosure is not limited to the above examples and may be applied to any field that uses longitudinal data.

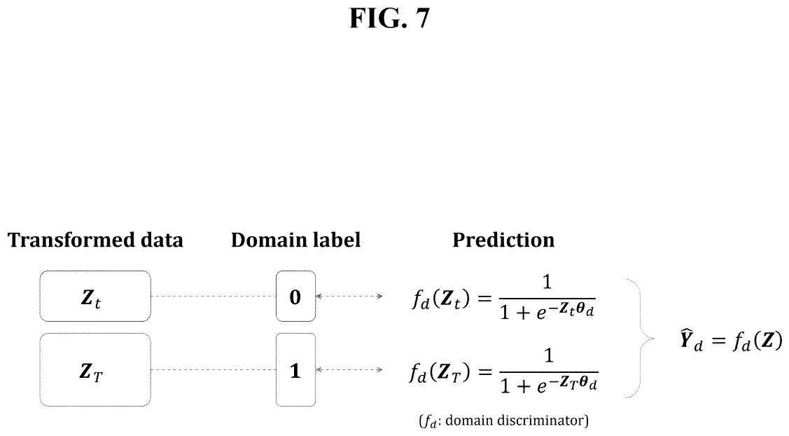

The second module 200 may include at least one processor that determines a domain of transformation data generated by the first module 100. The second module 200 may also be referred to as a domain discriminator. The second module 200 may determine the domain of the transformation data based on a predetermined equation. Specifically, the second module 200 may determine the domain of the transformation data using a discrimination parameter (θ_{d}) to output the result data 210 of the second module 200. The second module 200 will be described in detail below with reference to FIG. 7.

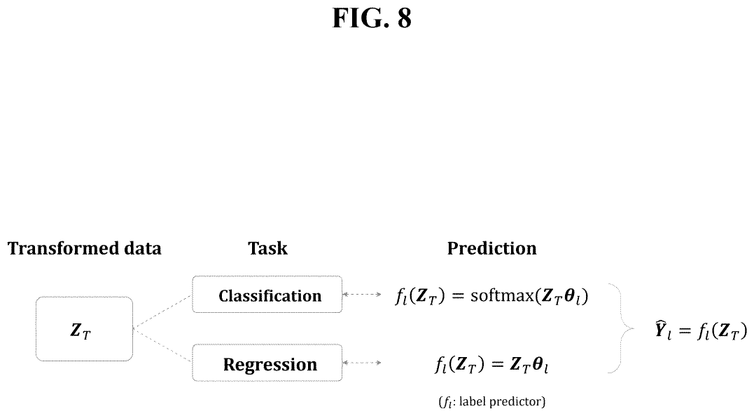

The third module 300 may include at least one processor that determines a label for the transformation data generated by the first module 100. The third module 300 may also be referred to as a label predictor. The third module 300 may determine a label for correct answer data for training an artificial intelligence model. Specifically, the third module 300 may determine the class and regression of comparison data (or current data) to output result data 310 of the third module 300. The third module 300 will be described in more detail below with reference to FIG. 8.

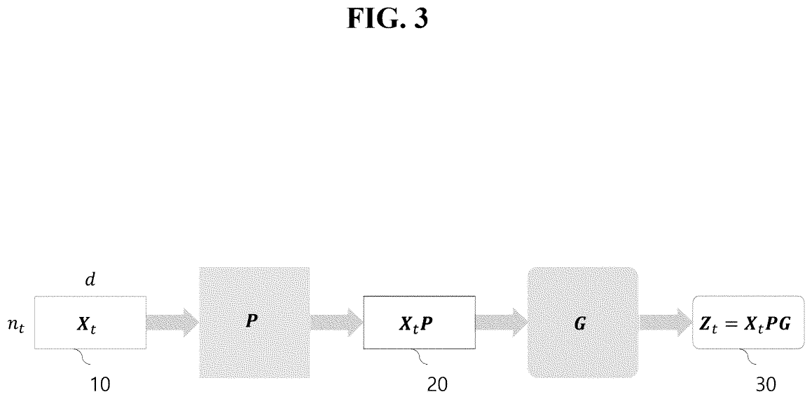

FIG. 3 is a diagram for describing a process for generating transformation data according to an embodiment.

Referring to FIG. 3, the first module 100 may identify a process of generating transformation data for the input data 10. Specifically, the first module 100 may generate the first latent data 20 by applying a projection matrix P to the input data 10. Further, the first module 100 may generate the second latent data 30 by applying a graph matrix G to the first latent data 20. In this case, the second latent data 30 may be transformation data that is the result data of the first module 100.

The first module 100 may generate various transformation data according to the input data. Although it is illustrated in the example of FIG. 3 that the input data 10 is past data (X_t), embodiments are not limited thereto and the first module 100 may generate transformation data for the current data even when the input data is current data (X_T).

The graph matrix G may be a matrix in which a weight matrix is normalized. In this case, the weight matrix may be set based on the graph of the covariance matrix of the comparison data (current data, X_T). Specifically, the graph matrix G may be calculated by [Equation 1] below.

$$G = {D}^{- \frac{1}{2}} {WD}^{- \frac{1}{2}} ∈ {ℝ}^{d \times d} \qquad [ Equation 1 ]$$

(W: graph of covariance matrix of comparison data (X_T), Dᵢᵢ=Σⱼ Wᵢⱼ)

FIG. 4 is a diagram for describing manifold of transformation data.

Referring to FIG. 4, the first module 100 may extract the manifold of transformation data using a graph matrix. The manifold may refer to an intrinsic feature of data. Specifically, the manifold may be features related to relationships between pieces of data. In the first module 100, the projection matrix P may be modified such that the difference between the manifold 41 of the past data and the manifold 42 of the current data is minimized, so that the two pieces of data that have been through the modified projection matrix have the same feature properties.

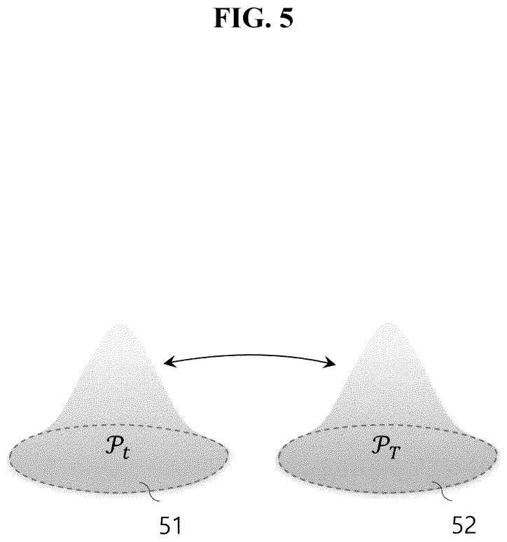

FIG. 5 is a diagram for describing a distribution of transformation data.

Referring to FIG. 5, the first module 100 may extract a distribution of transformation data using a graph matrix. The distribution may refer to an extrinsic feature of data. Specifically, the distribution may be a feature related to a distance between pieces of data. In the first module 100, the projection matrix P may be modified such that the difference between the distribution 51 of the past data and the distribution 52 of the current data is minimized, so that the two pieces of data that have been through the modified projection matrix have the same feature properties.

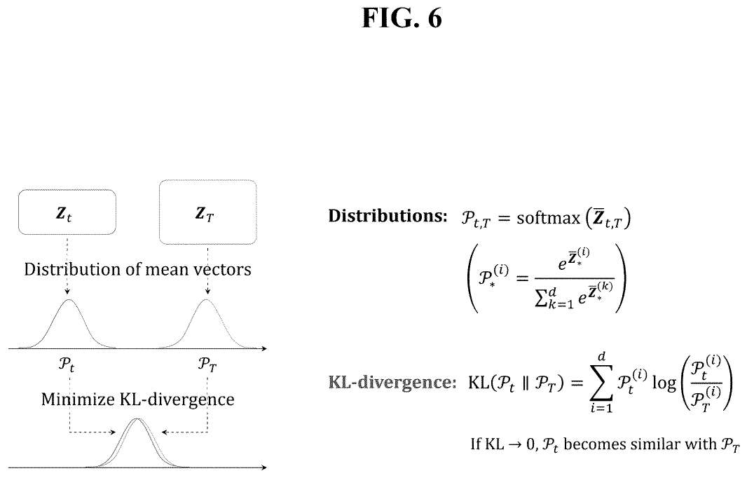

FIG. 6 is a diagram for describing a process for calculating a difference in distribution of transformation data.

Referring to FIG. 6, the first module 100 may calculate a distribution of mean vectors from first transformation data Z_t, which is the transformation data of past data, and second transformation data Z_T, which is the transformation data of current data. The first module 100 may calculate a difference between the distribution of the first transformation data and the distribution of the second transformation data using a Kullback-Leibler divergence function.

Specifically, the difference between the distributions of the pieces of transformation data may be calculated by [Equation 2] below.

$$K ( P ) = KL ( {𝒫}_{T} \vert \vert {𝒫}_{T} ) = {\sum }_{i = 1}^{d} {𝒫}_{t}^{( i )} log ( \frac{{𝒫}_{t}^{( i )}}{{𝒫}_{T}^{( i )}} ) \qquad [ Equation 2 ]$$

(K(P): second difference (difference in distribution), KL: Kullback-Leibler divergence function, [symbol] : probability for the mean of the first transformation data, [symbol] : probability for comparison data)

The first module 100 may continuously change the projection matrix P such that the difference in distribution converges to zero. Accordingly, the artificial intelligence model including the first module 100 may be continuously trained such that the difference in distribution is zero.

FIG. 7 is a diagram for describing a second module according to an embodiment.

Referring to FIG. 7, the second module 200 may determine a domain of the transformation data based on a predetermined equation. The second module 200 may output a first value when a domain of transformation data is determined to be a first time point, and a second value when the domain of the transformation data is determined to be a second time point. For example, but not limited to, the second module 200 may output a value of 0 when the domain of the transformation data is determined to be in the past, and a value of 1 when the domain of the transformation data is determined to be in the present or future.

The second module 200 may determine the domain based on [Equation 3] below.

$${\hat{Y}}_{d} = \frac{1}{1 + {e}^{- Z {θ}_{d}}} \qquad [ Equation 3 ]$$

(Ŷ_{d}: domain discrimination function, Z: first transformation data set, θ_{d}: discrimination parameter)

The discrimination parameter may be optimized by minimizing a binary cross-entropy loss function between the domain discrimination function and a domain label set. Specifically, the binary cross-entropy loss function may be calculated by [Equation 4] below.

$$D ( P , {θ}_{d} ) = - [ {Y}_{d}^{T} log {\hat{Y}}_{d} + {( 1 - {Y}_{d} )}^{T} log ( 1 - {\hat{Y}}_{d} ) ] \qquad [ Equation 4 ]$$

(D(P, θ_{d}): binary cross-entropy loss function, Ŷ_{d}: domain discrimination function, Y_{d}: domain label set)

FIG. 8 is a diagram for describing a third module according to an embodiment.

Referring to FIG. 8, the third module 300 may determine a class and a regression for comparison data (current data). The first module 100 may generate transformation data Z_T for comparison data X_T using a projection matrix and a graph matrix. The third module 300 may determine the class and regression of the comparison data based on the transformation data Z_T generated by the first module 100.

In this case, the class may be related to a discrete parameter, and the regression may be related to a continuous parameter. For example, when the comparison data is associated with a patient's medical data, the class may be gender (male/female) and the regression may be the patient's life expectancy (e.g., 80 years). Also, for example, when the comparative data is time series data related to a stock, the class may be the rise or fall of the stock, and the regression may be the expected price of the stock.

The third module 300 may determine the class and regression of the comparison data using [Equation 5] below.

$${\hat{Y}}_{l} = softmax ( {Z}_{T} {θ}_{l} ) \qquad [ Equation 5 ]$$

(Ŷₗ: label prediction function, Z_{T}: second transformation data, θₗ: label parameter)

In this case, the label parameter may be optimized by minimizing the cross-entropy loss function between the label prediction function and a set of correct labels. Specifically, the cross-entropy loss function may be calculated by [Equation 6] below.

$$( P , {θ}_{l} ) = - tr [ {Y}_{l}^{T} log {\hat{Y}}_{l} + {( 1 - {Y}_{l} )}^{T} log ( 1 - {\hat{Y}}_{l} ) ] \qquad [ Equation 6 ]$$

(L(P, θₗ): cross-entropy loss function, Ŷₗ: label prediction function, Yₗ: a set of correct labels)

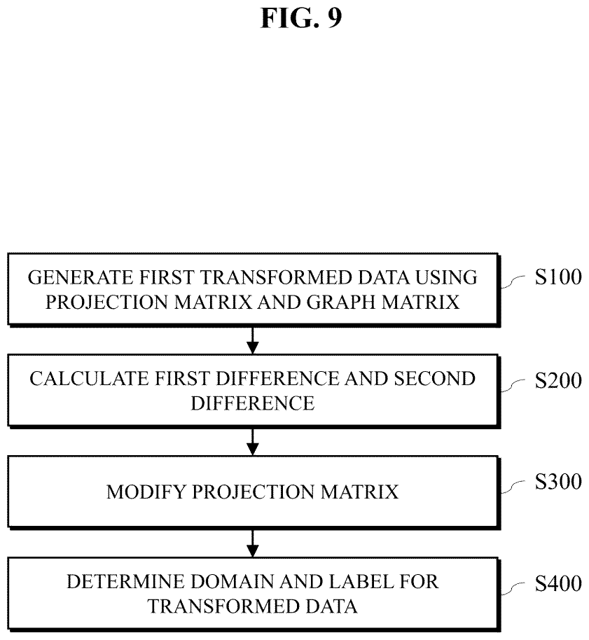

FIG. 9 is a flowchart of a domain adaptation method for longitudinal data according to an embodiment.

Referring to FIG. 9, a domain adaptation method for longitudinal data according to an embodiment may include generating first transformation data using a projection matrix and a graph matrix (S100), calculating a first difference and a second difference (S200), modifying the projection matrix (S300), and determining a domain and label for the transformation data (S400). Although it is illustrated in FIG. 9 that operations S100 to S400 are performed sequentially, embodiments are not limited thereto and some operations may be merged and performed simultaneously, some operations may be omitted, or new operations may be added.

The generating of the first transformation data using the projection matrix and the graph matrix (S100) may be an operation in which the first module 100 generates the transformation data by applying the projection matrix and the graph matrix to input data. For example, the first module 100 may generate the first transformation data based on past data X_t. Also, for example, the first module 100 may generate second transformation data based on current data X_T.

The calculating of the first difference and the second difference (S200) may be an operation in which the first module 100 calculates the first difference, which is a difference in manifold between the first transformation data and comparison data (current data), and the second difference, which is a difference in distribution between the first transformation data and comparison data. In this case, the first module 200 may calculate the second difference, which is the difference in distribution, using a Kullback-Leibler divergence function.

The modifying of the projection matrix (S300) may be an operation of continuously changing the value of the projection matrix such that the first difference and the second difference calculated in S200 converge to zero. By S300, the artificial intelligence model including the first module 100 may be trained.

The determining of the domain and label of the transformation data (S400) may be an operation of determining, by the second module 200 and the third module 300, the domain and label (including a class and a regression) associated with a time point of the transformation data.

As the description of S100 to S400 may be redundant with the above description, a detailed description will be omitted.

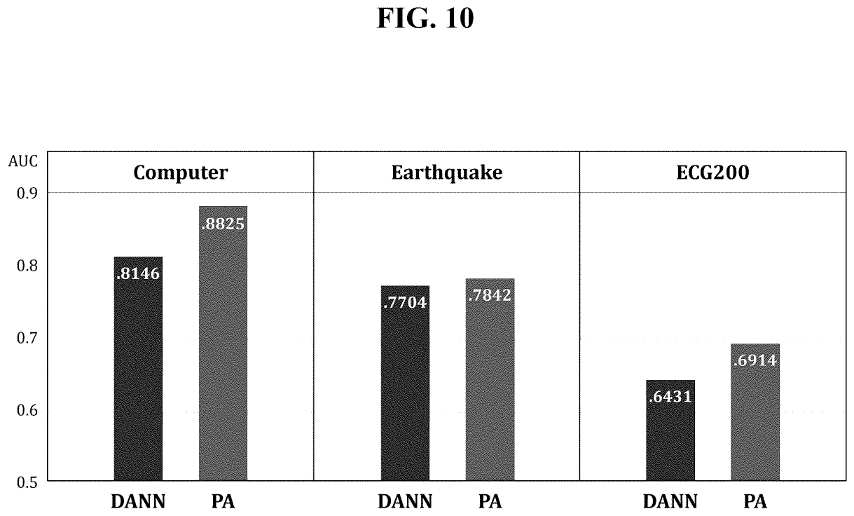

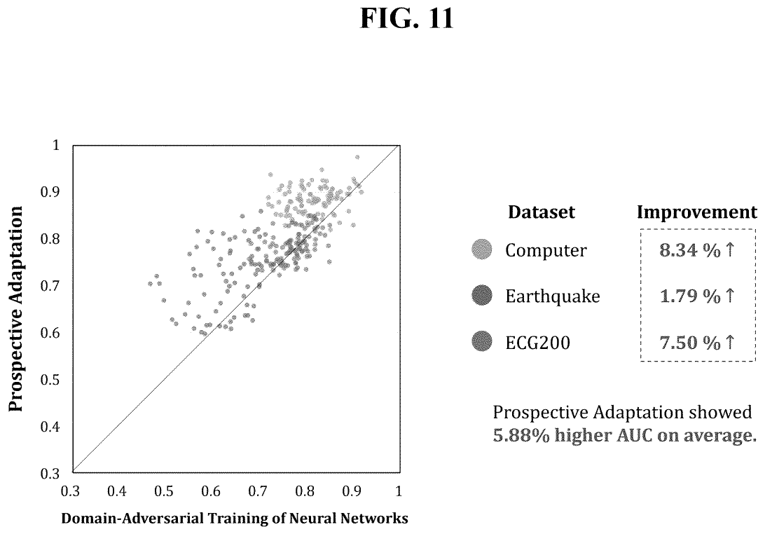

FIGS. 10 and 11 show results of comparison in performance of between the prior art and the domain adaptation device of the present disclosure.

Referring to FIG. 10, when comparing the AUC performance of the prior art (DANN) and the present disclosure (PA), it can be seen that the performance of the present disclosure is superior to the prior art in all aspects.

Referring to FIG. 11, it can be seen that the performance of the present disclosure is improved by at least 1.79% and at most 8.34% compared to the prior art.

The above-described methods may be embodied in the form of program instructions that can be executed by various computer means and recorded on a computer-readable medium. The computer readable medium may include program instructions, data files, data structures, and the like, alone or in combination. Program instructions recorded on the media may be those specially designed and constructed for the purposes of the inventive concept, or they may be of the kind well-known and available to those having skill in the computer software arts. Examples of computer readable recording media include magnetic media such as hard disks, floppy disks and magnetic tape, optical media such as CD-ROMs, DVDs, and magnetic disks such as floppy disks, Magneto-optical media, and hardware devices specifically configured to store and execute program instructions, such as ROM, RAM, flash memory, and the like. Examples of program instructions include not only machine code generated by a compiler, but also high-level language code that can be executed by a computer using an interpreter or the like. The hardware device described above may be configured to operate as one or more software modules to perform the operations of the present disclosure, and vice versa.

Although the embodiments have been described by the limited embodiments and the drawings as described above, various modifications and variations are possible to those skilled in the art from the above description. For example, the described techniques may be performed in a different order than the described method, and/or components of the described systems, structures, devices, circuits, etc. may be combined or combined in a different form than the described method, or other components, or even when replaced or substituted by equivalents, an appropriate result can be achieved.

Therefore, other implementations, other embodiments, and equivalents of the claims also fall within the scope of the claims described below.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A domain adaptation device for longitudinal data comprising:
a first module configured to generate first transformation data using a projection matrix for domain transformation and a graph matrix for data filtering;
a second module configured to determine a domain of the first transformation data; and
a third module configured to determine a label of the first transformation data.

2. The domain adaptation device of claim 1, wherein the first module is configured to:
calculate a first difference, which is a difference between manifold of the first transformation data and manifold of comparison data, and a second difference, which is a difference between distribution of the first transformation data and distribution of the comparison data; and
modify the projection matrix such that the first difference and the second difference decrease.

3. The domain adaptation device of claim 2, wherein the graph matrix is a matrix in which a weight matrix is normalized, and
wherein the weight matrix is set based on a graph of a covariance matrix of the comparison data.

4. The domain adaptation device of claim 2, wherein the second difference is calculated using the Kullback-Leibler divergence function.

5. The domain adaptation device of claim 1, wherein the first transformation data is calculated by the following equation:
$${Z}_{t} = {X}_{t} PG$$
where Zₜ: first transformation data, Xₜ: input data, and P: projection matrix, and G: graph matrix.

6. The domain adaptation device of claim 2, wherein the second difference is calculated by the following equation:
$$K ( P ) = KL ( {𝒫}_{T} \vert \vert {𝒫}_{T} ) = {\sum }_{i = 1}^{d} {𝒫}_{t}^{( i )} log ( \frac{{𝒫}_{t}^{( i )}}{{𝒫}_{T}^{( i )}} )$$
where K(P): second difference, KL: Kullback-Leibler divergence function, [symbol] : probability for a mean of the first transformation data, and [symbol] : probability for the comparison data.

7. The domain adaptation device of claim 1, wherein the second module is configured to:
determine the domain of the first transformation data based on a predetermined equation; and
output a first value when the domain of the first transformation data is determined to be a first time point, and a second value when the domain of the first transformation data is determined to be a second time point.

8. The domain adaptation device of claim 7, wherein the predetermined equation is as follows:
$${\hat{Y}}_{d} = \frac{1}{1 + {e}^{- Z {θ}_{d}}}$$
where Ŷ_{d}: domain discrimination function, Z: first transformation data set, and θ_{d}: discrimination parameter.

9. The domain adaptation device of claim 8, wherein the discrimination parameter is optimized by minimizing a binary cross-entropy loss function between the domain discrimination function and a domain label set.

10. The domain adaptation device of claim 9, wherein the binary cross-entropy loss function is calculated by the following equation:
$$D ( P , {θ}_{d} ) = - [ {Y}_{d}^{T} log {\hat{Y}}_{d} + {( 1 - {Y}_{d} )}^{T} log ( 1 - {\hat{Y}}_{d} ) ]$$
where D(P, θ_{d}): binary cross-entropy loss function, Ŷ_{d}: domain discrimination function, and Y_{d}: domain label set.

11. The domain adaptation device of claim 1, wherein the first module is configured to generate second transformation data to which comparison data has been transformed using the projection matrix and the graph matrix, and
wherein the third module is configured to determine a class and regression of the comparison data based on the second transformation data.

12. The domain adaptation device of claim 11, wherein the third module is configured to determine the class and regression of the comparison data using the following equation.
$${\hat{Y}}_{l} = softmax ( {Z}_{T} {θ}_{l} )$$
where Ŷₗ: label prediction function, Z_{T}: second transformation data, and θₗ: label parameter.

13. The domain adaptation device of claim 12, wherein the label parameter is optimized by minimizing the cross-entropy loss function between the label prediction function and a set of correct labels.

14. The domain adaptation device of claim 13, wherein the cross-entropy loss function is calculated by the following equation.
$$L ( P , {θ}_{l} ) = - tr [ {Y}_{l}^{T} log {\hat{Y}}_{l} + {( 1 - {Y}_{l} )}^{T} log ( 1 - {\hat{Y}}_{l} ) ]$$
where L(P, θₗ): cross-entropy loss function, Ŷₗ: label prediction function, and Yₗ: a set of correct labels.

15. A domain adaptation method for longitudinal data, which is performed by at least one processor, the domain adaptation method comprising:
generating first transformation data using a projection matrix for domain transformation and a graph matrix for data filtering;
calculating a first difference, which is a difference between manifold of the first transformation data and manifold of comparison data, and a second difference, which is a difference between distribution of the first transformation data and distribution of the comparison data; and
modifying the projection matrix such that the first difference and the second difference decrease.

16. A computer program stored in a computer-readable recording medium for executing the domain adaptation method for longitudinal data of claim 15.
